(19) United States
(12) Patent Application Publication
(10) Pub. No.: US 2011/0039482 A1
(43) Pub. Date: Feb. 17, 2011

(54) GRINDER

(76) Inventor: Terry Timmons, Milwaukee, WI (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/846,551

(22) Filed: Jul. 29, 2010

Related U.S. Application Data
(60) Provisional application No. 61/229,590, filed on Jul. 29, 2009.

(51) Int. Cl. B24B 23/02; B25F 5/02

(52) U.S. Cl. 451/344; 173/171

(57) ABSTRACT

A handheld grinder configured for use with an accessory tool that is removably coupled to the grinder, and the grinder includes a gear case, a spindle, and a fastener coupled to the spindle to apply a clamping force to the accessory tool. The grinder further includes a first race, a second race, a third race, a recess formed in the third race. A release member moves along the first race, the second race, and the third race. The release member moves along the third race and into the recess in response to the spindle being rotated about a longitudinal axis with respect to the gear case in a first direction, and the release member moves in a direction radially away from the longitudinal axis of the spindle when the release member moves into the recess thereby decreasing a vertical distance between the first race and the second race to decrease a clamping force.

### CROSS-REFERENCE TO RELATED APPLICATIONS

This application claims priority to U.S. Provisional Patent Application No. 61/229,590, filed Jul. 29, 2009, the entire contents of which are hereby incorporated by reference herein.

### BACKGROUND

The present invention relates to power tools, such as grinders.

Grinders typically include a motor housing and a gear case housing. The motor housing often forms a handle of the grinder that the user grabs to hold the grinder with a first hand. An auxiliary handle can be coupled to the gear case housing or the motor housing to provide the user with a place to hold the grinder with a second hand. An actuator, such as a paddle switch is often located on the motor housing to allow the user to operate the grinder using the first hand.

Grinders also typically include a spindle that is rotated by a motor of the grinder. An accessory tool, such as a grinding disk, wire brush, or the like is removably coupled to the spindle. Often a threaded nut is used to attach the accessory tool to the spindle. The nut is rotated in a first direction to attach the nut to the spindle and apply a clamping force to the accessory tool and the nut is rotated in a second or opposite direction to remove the nut and the accessory tool from the spindle. Typically, the grinder includes a spindle lock to inhibit rotation of the spindle when the accessory tool is being attached and removed from the spindle.

### SUMMARY

In one embodiment, the invention provides a handheld grinder configured for use with an accessory tool that is removably coupled to the grinder. The grinder includes a gear case and a spindle. The spindle includes a first end disposed within the gear case, a second end disposed outside of the gear case, and a length that extends from the first end to the second end. The spindle defines a longitudinal axis that extends centrally through the spindle along the length of the spindle, and the spindle is coupled to the gear case such that the spindle rotates about the longitudinal axis with respect to the gear case and the spindle is movable along the longitudinal axis with respect to the gear case. A fastener is coupled to the second end of the spindle to apply a clamping force to the accessory tool. The grinder further includes a first race that extends circumferentially around at least a portion of the longitudinal axis, and the first race is coupled to the spindle for movement with the spindle along the longitudinal axis. A second race extends circumferentially around at least a portion of longitudinal axis, and the spindle and the first race are movable along the longitudinal axis of the spindle with respect to the second race and the gear case. The second race is spaced a vertical distance from the first race, and the vertical distance is measured parallel to the longitudinal axis of the spindle. A third race extends circumferentially around at least a portion of the longitudinal axis of the spindle, and the third race extends at least partially between the first race and the second race in a direction along the longitudinal axis of the spindle. A recess formed in the third race. The grinder further includes a release member that moves along the first race, the second race, and the third race. The release member moves along the third race and into the recess in response to the spindle being rotated about the longitudinal axis with respect to the gear case in a first direction. The release member moves in a direction radially away from the longitudinal axis of the spindle when the release member moves into the recess thereby decreasing the vertical distance between the first race and the second race to decrease the clamping force.

In another embodiment the invention provides a power tool configured for use with an accessory tool that is removably coupled to the power tool. The power tool includes a gear case and a spindle. The spindle includes a first end disposed within the gear case, a second end disposed outside of the gear case, and a length that extends from the first end to the second end. The spindle defines a longitudinal axis that extends centrally through the spindle along the length of the spindle. The spindle is coupled to the gear case such that the spindle rotates about the longitudinal axis with respect to the gear case and the spindle is movable along the longitudinal axis with respect to the gear case. A fastener is coupled to the second end of the spindle to apply a clamping force to the accessory tool. A flange is coupled to the spindle for movement with the spindle along the longitudinal axis, and the flange includes a first tapered race that extends circumferentially around the longitudinal axis. A second tapered race extends circumferentially around the longitudinal axis, and the spindle and the flange are movable along the longitudinal axis of the spindle with respect to the second tapered race and the gear case. The second tapered race is spaced a vertical distance from the first tapered race, and the vertical distance measured parallel to the longitudinal axis of the spindle. A third race extends circumferentially around the longitudinal axis of the spindle, and the third race extends at least partially between the first tapered race and the second tapered race in a direction along the longitudinal axis of the spindle. The third race includes a recess, and a roller that rolls along the first tapered race, the second tapered race, and the third race. The roller moves along the third race and into the recess in response to the spindle being rotated about the longitudinal axis with respect to the gear case in a first direction, and the roller moves in a direction radially away from the longitudinal axis of the spindle when the roller moves into the recess thereby decreasing the vertical distance between the first tapered race and the second tapered race to decrease the clamping force.

Other aspects of the invention will become apparent by consideration of the detailed description and accompanying drawings.

### BRIEF DESCRIPTION OF THE DRAWINGS

FIG. 1 is a perspective view of a power tool according to one embodiment of the invention.

FIG. 2 is a cross-sectional view of the power tool of FIG. 1 taken along line 2-2 of FIG. 1.

FIG. 3 is a cross-sectional view of the power tool of FIG. 1 taken along line 3-3 of FIG. 1 with a portion of the gear case removed.

FIG. 4 is a perspective view of a portion of a spindle assembly of the power tool of FIG. 1.

FIG. 5 is a cross-sectional view of the portion of the spindle assembly of FIG. 4 taken along line 5-5 of FIG. 4.

FIG. 6 is a top view of a portion of the spindle assembly of FIG. 4.

FIG. 7 is a perspective view of a portion of a spindle assembly according to another embodiment of the invention.

FIG. 8 is a top view of a sleeve of the spindle assembly of FIG. 7.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

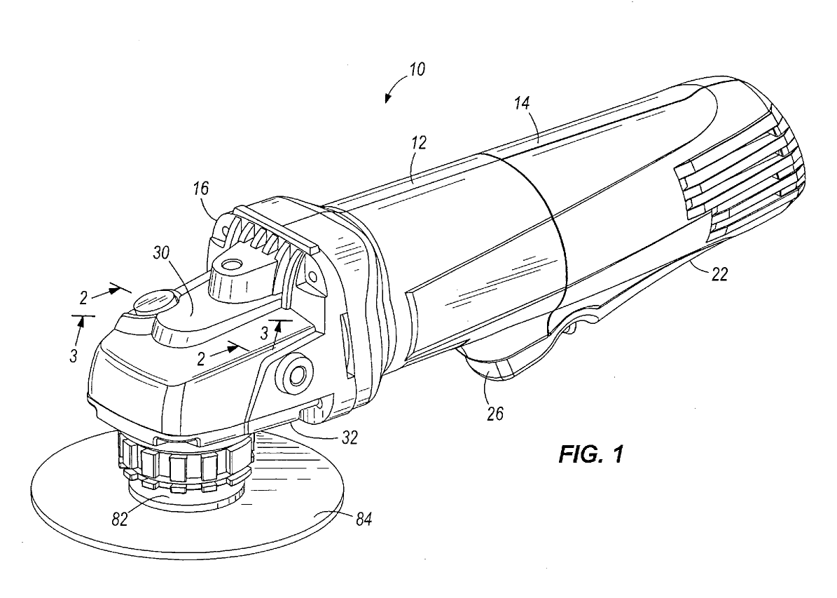

FIG. 1 illustrates a power tool 10, which is a grinder in the illustrated embodiment. The grinder 10 has a housing 12, which includes a motor housing portion 14 and a gear case portion 16. In the embodiment shown, the motor housing portion 14 is a separate component from the gear case portion 16 and in one embodiment the motor housing portion 14 is formed from composite materials, such as nylon and glass-filled nylon. The gear case portion 16 may be a metal gear case formed from materials, such as aluminum or magnesium.

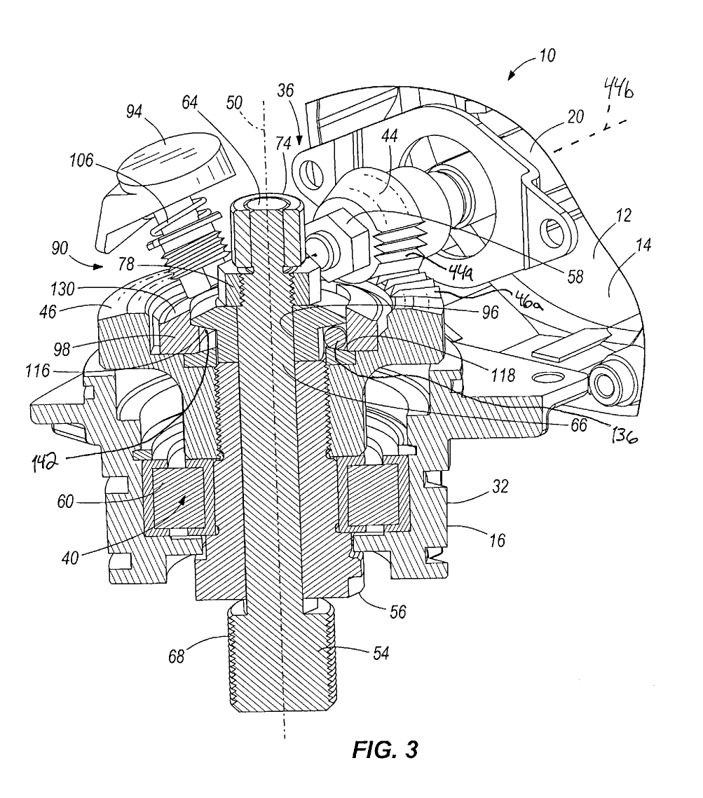

The motor housing portion 14 encloses a motor (not shown) having a motor shaft 20 (FIG. 3). The motor housing portion 14 also defines a handgrip area 22. The motor housing portion 14 supports an actuation switch 26, such as a paddle switch, for activating and deactivating the tool 10.

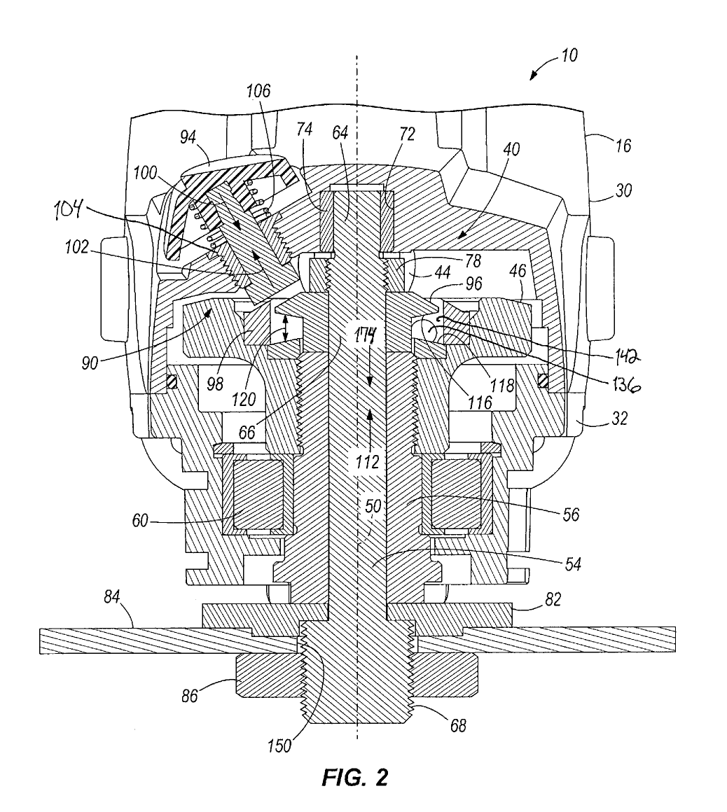

As shown in FIGS. 1 and 2, the gear case portion 16 includes a first or upper gear case portion 30 and a second or lower gear case portion 32. In the illustrated embodiment, the first and second gear case portions 30, 32 are separate components. The first gear case portion 30 is fixedly attached to the motor housing portion 14 and the second gear case portion 32 is fixedly attached to the first gear case portion 30. The second gear case portion 32 is configured to support a grinder guard assembly (not shown).

Referring to FIG. 3, the gear case portion 16 substantially encloses and supports a drive mechanism 36 and a spindle assembly 40. The drive mechanism 36 includes a driving gear 44 and a driven gear 46. In the illustrated embodiment, the driving gear 44 and the driven gear 46 are both bevel gears, and the driving gear 44 includes teeth 44a and the driven gear includes teeth 46a. The driving gear 44 is rotated by the motor shaft 20 about a driving gear axis 44b and the teeth 44a, 46a are engaged such that rotation of the driving gear 44 by the motor shaft 20 rotates the driven gear 46.

The spindle assembly 40 defines a longitudinal or vertical axis 50 and includes an inner shaft or spindle 54 and an outer shaft 56. The outer shaft 56 is coupled for rotation with the driven gear 46 and the spindle 54 is coupled for rotation with the outer shaft 56. Therefore, the driven gear 46 rotates the outer shaft 56 and the outer shaft 56 rotates the spindle 54. However, the spindle 54 is coupled to the outer shaft 56 such that the spindle 54 is movable with respect to the outer shaft 56 along the axis 50.

The driven gear 46 is secured via threads to the outer shaft 56. This causes the location of the outer shaft 56 to be axially fixed within the gear case 16 and the outer shaft 56 is rotatable via the driven bevel gear 46 with respect to the gear case 16. The driving bevel gear 44 is secured to the motor shaft 20 using a nut 58 that presses the driving gear 44 against a shoulder of the motor shaft 20. The driving bevel gear 44 drives or rotates the driven bevel gear 46. A bearing 60 is positioned around the outer shaft 56 of the spindle assembly 40 to facilitate rotation of the outer shaft 56 and the spindle 54 with respect to the gear case 16.

Referring to FIGS. 2 and 3, the spindle 54 includes an upper end or first end 64, a middle portion 66, and a lower end or second end 68. The upper end 64 is received in an aperture 72 of the upper gear case portion 30. A bearing 74 is located within the aperture 72 to support the spindle 54 for rotation with respect to the gear case 16. The middle portion 66 of the spindle 54 includes a threaded portion that receives a nut 78. As illustrated in FIG. 2, the lower end 68 is configured to support a flange 82, an accessory tool 84, such as a grinding wheel or disc, and a fastener 86, which is a locking nut in the illustrated embodiment. The grinding wheel 84 is positioned onto the lower end 68 beneath the flange 82 and secured to the spindle 54 with the locking nut 86 as will be discussed in more detail below.

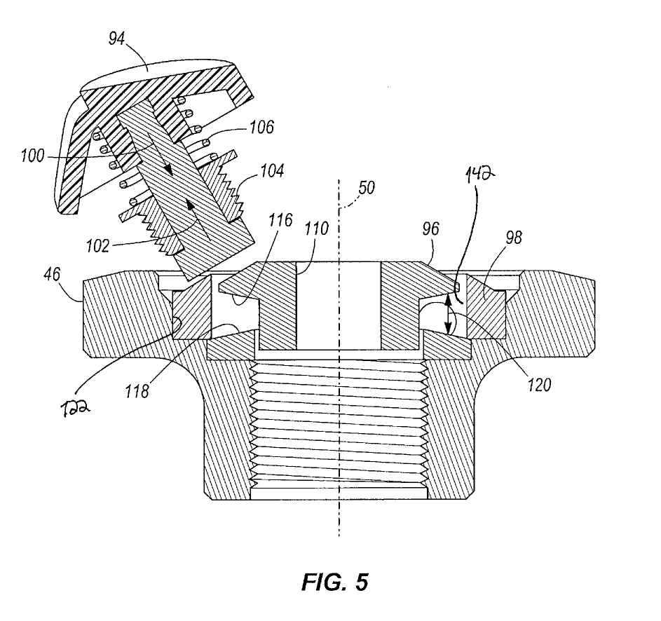

Referring to FIGS. 2 and 5, the grinder 10 further includes a spindle lock and release assembly 90. The assembly 90 includes a spindle lock 94, an upper flange 96, and a sleeve 98. The spindle lock 94 slides in the direction of arrows 100 and 102 within a bushing 104 that is located within an aperture formed in the upper gear case portion 30. A spring 106 biases the spindle lock 94 in the direction of arrow 102.

Referring to FIGS. 2, 4, and 5, the upper flange 96 includes a double ‘D’ shaped aperture 110 that extends through the upper flange 96 and is used to couple the upper flange 96 to the spindle 54 for co-rotation. The nut 78 limits movement of the upper flange 96 along the spindle 54 in the direction of arrow 112. As best seen in FIG. 5, the upper flange 96 also includes a first tapered race 116 that faces a second tapered race 118 of the driven gear 46. The races 116 and 118 are tapered such that there is a greater distance 120 between the races 116 and 118 radially outward or further from the spindle axis 50 than radially inward or closer to the spindle axis 50.

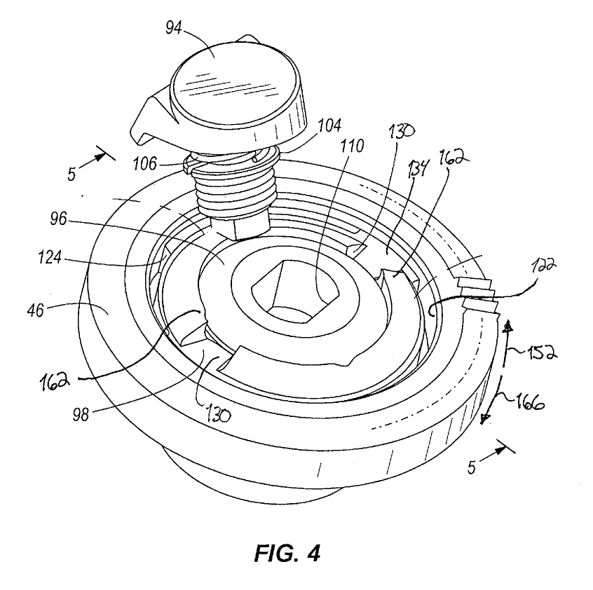

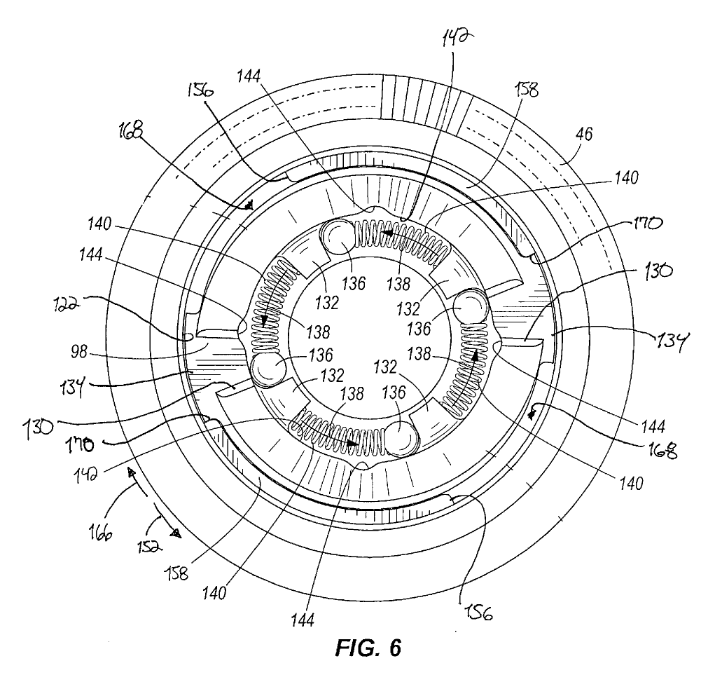

Referring to FIGS. 4-6, the sleeve 98 is annular and surrounds the longitudinal axis 50 and the upper flange 96 within a recess 122 of the driven gear 46. The sleeve 98 includes recesses 130, radially inward projecting tabs 132, and radially outward projecting tabs 134 (FIG. 6). Release members 136 are located within the sleeve 98. In the illustrated embodiment, the release members 136 are balls. In other embodiments, the release members can include rollers, cam members, sliders, and the like. Each of the balls 136 is biased in the direction of arrow 138 by a biasing member 140, which is a compression spring in the illustrated embodiment that presses against one of the adjacent tabs 132. As best seen in FIG. 6, the sleeve 98 further includes a third race 142 that surrounds the longitudinal axis 50 (FIG. 5). Recesses 144 are formed on the race 142 of the sleeve 98. In the illustrated embodiment, there is one recess 144 for each ball 136, and the recesses 144 are formed between each of the tabs 132. When the grinder 10 is assembled, the balls 136 roll along the races 116, 118, 142.

Referring to FIG. 2, in operation, to attach the grinding wheel 84 to the grinder 10, the user places the spindle 54 through a central aperture 150 of the grinding wheel 84, as illustrated in FIG. 2, and threads or rotates the nut 86 onto the threaded lower end 68 of the spindle 54. To tighten the nut 86 to apply a clamping force to the grinding wheel 84, the nut 86 is rotated clockwise in the illustrated embodiment when viewed from the lower end 68 of the spindle 54 (hereinafter “tightening direction”). The tightening direction is also indicated by an arrow 152 of FIG. 6. As the user tightens the nut 86, the grinding wheel 84 presses against the flange 82, and the flange 82 presses against the outer shaft 56.

Tightening the nut 86 also rotates the spindle 54. Therefore, the user presses the spindle lock 94 in the direction of arrow 100 to an engaged or locked position (FIG. 4). Referring to FIGS. 2 and 4, rotation of the spindle 54 in the tightening direction 152 also rotates the driven gear 46 because the driven gear 46 and the spindle 54 are coupled for co-rotation. The driven gear 46 and the spindle 54 rotate with respect to the sleeve 98 in the tightening direction 152 until a first end 156 (FIG. 6) of a projection 158 within the recess 122 of the gear 46 contacts the projection 134 of the sleeve 98. Then, the sleeve 98, the spindle 54, and the gear 46 rotate together about the axis 50 until the spindle lock 94 is received in one of the recesses 130 of the sleeve 98 because the user is pressing on the spindle lock 94. With the spindle lock 94 received in one of the recesses 130, the user can rotate the nut 86 in the tightening direction 152 without rotating the spindle 54. Then, the user tightens the nut 86 to a desired torque to apply the clamping force to the grinding wheel 84 and releases the spindle lock 94. The spring 106 moves the spindle lock 94 in the direction of arrow 102 to a disengaged position (FIG. 2) so that the spindle lock 94 does not contact either the sleeve 98 or the upper flange 96 when the grinder 10 is in use. Referring to FIG. 4, the sleeve 98 includes ramps 162 adjacent each of the recesses 130. The ramps 162 inhibit the spindle lock 94 from being pressed into the recesses 130 by the user when the grinder 10 is in use because the ramps 162 cause the spindle lock 94 to jump over the recesses 130 if the spindle lock 94 is pressed and the grinder 10 is in use.

With the nut 86 tightened, the balls 136 (FIG. 6) are in the position illustrated in FIG. 6 and the balls 136 are pressed between the tapered race 116 of the upper flange 96 and the tapered race 118 of the driven gear 46, which forces the balls 136 radially outward to press against the race 142 of the sleeve 98 (FIG. 3).

With continued reference to FIGS. 2 and 4, to remove the grinding wheel 84, the user presses the spindle lock 94 to move the spindle lock 94 back to the engaged position. Also, the user rotates the nut 86 in the counterclockwise direction in the illustrated embodiment when viewed from the lower end 68 of the spindle 54 (hereinafter “releasing direction”). The releasing direction is also indicated by the arrow 166 of FIG. 6. Rotating the nut 86 in the releasing direction also rotates the spindle 54 and the driven gear 46 in the releasing direction. Friction between the driven gear 46, the upper flange 96, and the sleeve 98 via the balls 136 causes the sleeve 98 to also rotate in the releasing direction 166. However, as illustrated in FIG. 4, with the spindle lock 94 in the engaged position, sleeve 98 rotates until the spindle lock 94 is received in one of the recesses 130 of the sleeve 98. With the spindle lock 94 received one of the recesses 130, the spindle lock 94 fixes or holds the sleeve 98 from rotating with the gear 46 and spindle 54. Therefore, the driven gear 46, the upper flange 96, and the balls 136 begin to rotate with respect to the sleeve 98 in the releasing direction 166. A circumferential gap 168 between the first end 156 of one of the projections 158 and a second end 170 of the other projection 158 allows a fixed amount of rotational movement of the gear 46 with respect to the sleeve 98.

The driven gear 46, the upper flange 96, and the balls 136 continue to rotate with respect to the sleeve 98 in the releasing direction 166 until the balls 136 are adjacent the recesses 144 of the race 142, which cases the balls 136 to move in a direction radially outward with respect to the spindle axis 50 and into one of the recesses 144. By moving into the recesses 144, the balls 136 move radially away from the spindle axis 50 where there is a greater distance 120 (FIG. 5) between the tapered races 116 and 118. When the balls 136 move radially outward, the upper flange 96, and therefore, the spindle 54, drop or move slightly in the direction of arrow 174 (FIG. 2) because of gravity or the clamping force from the nut 86 that pulls the nut 78 in the direction of arrow 174. This movement creates a small gap between the flange 82 and the outer shaft 56 thereby releasing the tension or clamping force that was holding the wheel 84 onto the spindle 54. The user can now rotate the nut 86 in the releasing direction with less torque than the torque that was used to tighten the nut 86. Thus, the spindle lock and release mechanism 90 allows the user to tighten the nut 86 onto the spindle 54 of the grinder 10 to a desired torque and remove the nut 86 and wheel 84 with less torque than was used to tighten the nut 86 and wheel 84.

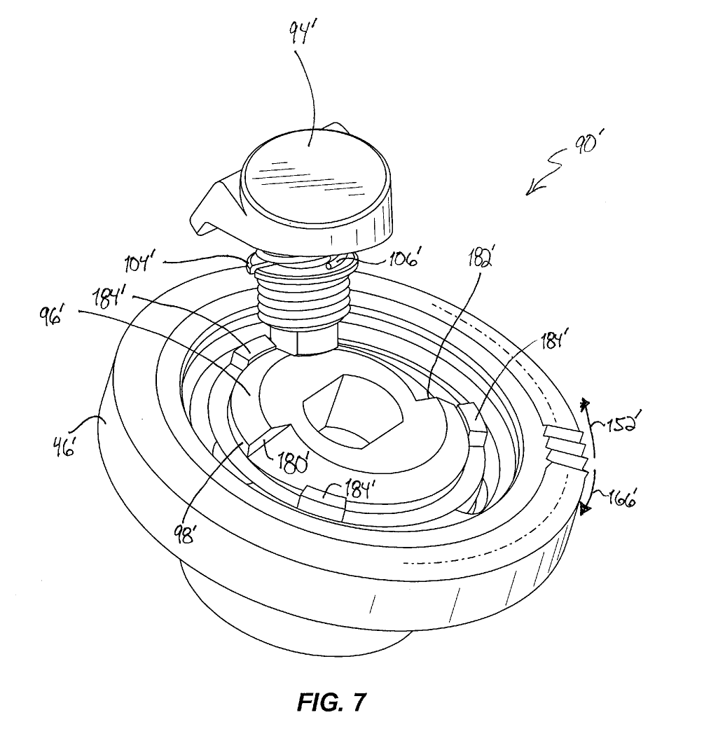

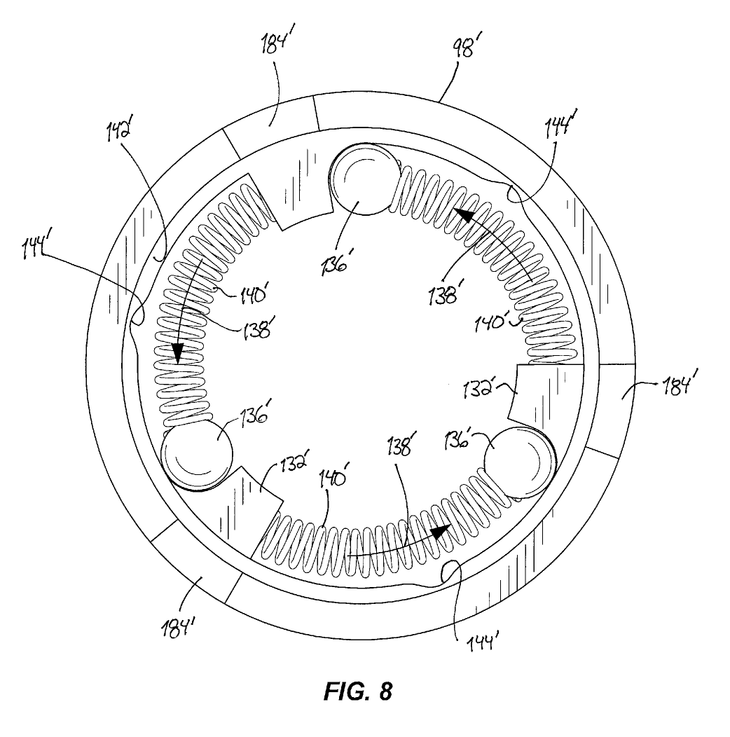

FIGS. 7 and 8 illustrate an alternative embodiment of the spindle lock and release mechanism 90 of FIGS. 1-6. The spindling lock and release mechanism 90′ of FIGS. 7 and 8 is similar to the lock and release mechanism 90 and therefore only differences will be discussed in detail below and like components have been given like reference numbers with a prime symbol.

Referring to FIG. 7, the upper flange 96′ includes a first ledge 180′ and a second ledge 182′. The ledges 180′, 182′ allow the flange 96′, and therefore the spindle, to rotate in the releasing direction 166′ when the spindle lock 94′ is in the locked position. However, the ledges 180′, 182′ contact the spindle lock 94′ when the spindle lock 94′ is in the locked position and the spindle is rotated in the tightening direction 152′ to fix the flange 96′ and the spindle from rotating when the nut is being tightened onto the spindle and the clamping force is being applied to the grinding wheel. Referring to FIGS. 7 and 8, the sleeve 98′ includes upstanding tabs 184′ that contact the spindle lock 94′ when the spindle lock 94′ is in the locked position so that when the spindle, the flange 96′, and the sleeve 98′ are rotated in the releasing direction 166′ the sleeve 98′ is held fixed to allow the balls 136′ to align and move into the recesses 144′.

Although the invention has been described in detail with reference to certain preferred embodiments, variations and modifications exist within the scope and spirit of one or more independent aspects of the invention as described. Various features and advantages of the invention are set forth in the following claims.

What is claimed is:

1. A handheld grinder configured for use with an accessory tool that is removably coupled to the grinder, the grinder comprising:
a gear case;
a spindle including a first end disposed within the gear case, a second end disposed outside of the gear case, and a length that extends from the first end to the second end, the spindle defining a longitudinal axis that extends centrally through the spindle along the length of the spindle, the spindle coupled to the gear case such that the spindle rotates about the longitudinal axis with respect to the gear case and the spindle is movable along the longitudinal axis with respect to the gear case;
a fastener coupled to the second end of the spindle to apply a clamping force to the accessory tool;
a first race that extends circumferentially around at least a portion of the longitudinal axis, the first race coupled to the spindle for movement with the spindle along the longitudinal axis;
a second race that extends circumferentially around at least a portion of longitudinal axis, the spindle and the first race movable along the longitudinal axis of the spindle with respect to the second race and the gear case, the second race is spaced a vertical distance from the first race, the vertical distance measured parallel to the longitudinal axis of the spindle;
a third race that extends circumferentially around at least a portion of the longitudinal axis of the spindle, the third race extending at least partially between the first race and the second race in a direction substantially parallel to the longitudinal axis of the spindle;
a recess formed in the third race;
a release member that moves along the first race, the second race, and the third race;
wherein the release member moves along the third race and into the recess in response to the spindle being rotated about the longitudinal axis with respect to the gear case in a first direction,
wherein the release member moves in a direction radially away from the longitudinal axis of the spindle when the release member moves into the recess thereby decreasing the vertical distance between the first race and the second race to decrease the clamping force.

2. The handheld grinder of claim 1, wherein the first race and the second race are tapered such that the vertical distance increases in the direction radially away from the longitudinal axis of the spindle.

3. The handheld grinder of claim 1, further comprising a flange that circumferentially surrounds the longitudinal axis of the spindle, wherein the first race is formed on the flange, and wherein the flange is coupled to the spindle so that the flange, including the first race, moves with the spindle along the longitudinal axis.

4. The handheld grinder of claim 1, wherein the second end of the spindle is threaded, and wherein the fastener includes a nut.

5. The handheld grinder of claim 1, wherein the release member moves along the third race about the longitudinal axis of the spindle to move into the recess.

6. The handheld grinder of claim 5, wherein the release member moves along the third race about the longitudinal axis of the spindle in the first direction to move into the recess.

7. The handheld grinder of claim 1, wherein when the release member moves in the direction radially away from the longitudinal axis of the spindle and the release member moves into the recess, the vertical distance between the first race and the second race is decreased and the spindle moves in a direction along the longitudinal axis of the spindle with respect to the gear case to decrease the clamping force.

8. The handheld grinder of claim 7, wherein the fastener is coupled to the spindle for movement with the spindle along the longitudinal axis.

9. The handheld grinder of claim 1, further comprising a spindle lock movable between a locked position and an unlocked position, wherein in the locked position the spindle lock holds the third race from rotation with respect to the gear case about the longitudinal axis of the spindle when the spindle is rotated about the longitudinal axis with respect to the gear case in the first direction.

10. The handheld grinder of claim 9, wherein when the spindle lock is in the locked position, the spindle lock holds the spindle from rotation with respect to the gear case about the longitudinal axis of the spindle in a second direction that is opposite the first direction to allow a user rotate the fastener with respect to the spindle to apply the clamping force.

11. The handheld grinder of claim 10, wherein the spindle is coupled to the third race for rotation a fixed distance with respect to the third race about the longitudinal axis of the spindle when the spindle lock is in the locked position.

12. The handheld grinder of claim 9, further comprising a sleeve, wherein the sleeve includes the third race and a notch, and wherein the spindle lock engages the notch when the spindle lock is in the locked position.

13. The handheld grinder of claim 1, further comprising a biasing member that biases the release member in the first direction.

14. The handheld grinder of claim 1, further comprising a plurality of release members and a plurality of recesses.

15. The handheld grinder of claim 1, further comprising, a driving gear disposed within the gear case, the driving gear rotatable about a driving gear axis; and a driven gear disposed with in the gear case and coupled for rotation with the spindle with respect to the gear case about the longitudinal axis of the spindle, wherein the driving gear is coupled to the driven gear to rotate the driven gear and the spindle with respect to the gear case about the longitudinal axis of the spindle.

16. The handheld grinder of claim 15, wherein the driving gear axis is perpendicular to the longitudinal axis such that the handheld grinder is an angle grinder.

17. The handheld grinder of claim 15, wherein the second race is coupled to the driven gear for co-rotation with respect to the gear case about the longitudinal axis of the spindle.

18. The handheld grinder of claim 15, wherein the driven gear includes a recess, wherein the second race is located within the recess of the driven gear.

19. The handheld grinder of claim 15, wherein the driven gear includes a plurality of teeth that extend circumferentially around the longitudinal axis of the spindle, and wherein the second race is located radially between the longitudinal axis of the spindle and the plurality of teeth.

20. The handheld grinder of claim 19, wherein the third race is located on a sleeve, wherein the sleeve is located within the recess of the driven gear.

21. The handheld grinder of claim 15, wherein the spindle is movable along the longitudinal axis of the spindle with respect to the driven gear.

22. The handheld grinder of claim 1, wherein the third race is an outer race.

23. The handheld grinder of claim 1, wherein the first race, the second race, and the third race are located within the gear case.

24. A power tool configured for use with an accessory tool that is removably coupled to the power tool, the power tool comprising:
a gear case;
a spindle including a first end disposed within the gear case, a second end disposed outside of the gear case, and a length that extends from the first end to the second end, the spindle defining a longitudinal axis that extends centrally through the spindle along the length of the spindle, the spindle coupled to the gear case such that the spindle rotates about the longitudinal axis with respect to the gear case and the spindle is movable along the longitudinal axis with respect to the gear case;
a fastener coupled to the second end of the spindle to apply a clamping force to the accessory tool;
a flange coupled to the spindle for movement with the spindle along the longitudinal axis, the flange including a first tapered race that extends circumferentially around the longitudinal axis;
a second tapered race that extends circumferentially around the longitudinal axis, the spindle and the flange movable along the longitudinal axis of the spindle with respect to the second tapered race and the gear case, the second tapered race is spaced a vertical distance from the first tapered race, the vertical distance measured parallel to the longitudinal axis of the spindle;
a third race that extends circumferentially around the longitudinal axis of the spindle, the third race extending at least partially between the first tapered race and the second tapered race in a direction along the longitudinal axis of the spindle, the third race including a recess;
a roller that rolls along the first tapered race, the second tapered race, and the third race,
wherein the roller moves along the third race and into the recess in response to the spindle being rotated about the longitudinal axis with respect to the gear case in a first direction,
wherein the roller moves in a direction radially away from the longitudinal axis of the spindle when the roller moves into the recess thereby decreasing the vertical distance between the first tapered race and the second tapered race to decrease the clamping force.

25. The power tool of claim 24, wherein when the roller moves in the direction radially away from the longitudinal axis of the spindle and the roller moves into the recess, the vertical distance between the first tapered race and the second tapered race is decreased and the spindle moves in a direction along the longitudinal axis of the spindle with respect to the gear case to decrease the clamping force.

26. The power tool of claim 25, wherein the fastener is coupled to the spindle for movement with the spindle along the longitudinal axis.

27. The power tool of claim 24, further comprising a spindle lock movable between a locked position and an unlocked position, wherein in the locked position the spindle lock holds the third tapered race from rotation with respect to the gear case about the longitudinal axis of the spindle when the spindle is rotated about the longitudinal axis with respect to the gear case in the first direction.

28. The power tool of claim 24, wherein when the spindle lock is in the locked position, the spindle lock holds the spindle from rotation with respect to the gear case about the longitudinal axis of the spindle in a second direction that is opposite the first direction to allow a user to apply the clamping force using the fastener.

29. The power tool of claim 28, wherein the spindle is coupled to the third tapered race for rotation a fixed distance with respect to the third tapered race about the longitudinal axis of the spindle when the spindle lock is in the locked position.

30. The power tool of claim 24, further comprising a sleeve, wherein the sleeve includes the third race and a notch, and wherein the spindle lock engages the notch when the spindle lock is in the locked position.

31. The power tool of claim 24, wherein the roller includes a ball.

32. The power tool of claim 24, further comprising a biasing member that biases the roller in the first direction.

33. The power tool of claim 24, further comprising a plurality of rollers, and wherein the third race includes a plurality of recesses.

34. The power tool of claim 24, further comprising a driving gear disposed within the gear case; and a driven gear disposed with in the gear case and coupled for rotation with the spindle with respect to the gear case about the longitudinal axis of the spindle, wherein the driving gear is coupled to the driven gear to rotate the driven gear and the spindle with respect to the gear case about the longitudinal axis of the spindle.

35. The power tool of claim 34, wherein the second tapered race is coupled to the driven gear for co-rotation with respect to the gear case about the longitudinal axis of the spindle.

36. The power tool of claim 34, wherein the driven gear includes a recess, wherein the second tapered race is located within the recess of the driven gear.

38. The power tool of claim 34, wherein the driven gear includes a plurality of teeth that extend circumferentially around the longitudinal axis of the spindle, and wherein the second tapered race is located radially between the longitudinal axis of the spindle and the plurality of teeth.

39. The power tool of claim 38, wherein the third race is located on a sleeve, wherein the sleeve is located within the recess of the driven gear.

40. The power tool of claim 34, wherein the spindle is movable along the longitudinal axis of the spindle with respect to the driven gear.

41. The power tool of claim 24, wherein the third race is an outer race.

42. The power tool of claim 24, wherein the flange, the first tapered race, the second tapered race, and the third race are located within the gear case.
